(19) United States
(12) Patent Application Publication
(10) Pub. No.: US 2009/0045108 A1
(43) Pub. Date: Feb. 19, 2009

(54) Sewer Reservoir

(76) Inventor: Jeffery T. Franks, Beaumont, TX (US)

Correspondence Address: THE DICKINSON LAW OFFICES;ATTN: DAVID DICKINSON, PO BOX 801619, HOUSTON, TX, 77280, US

(21) Appl. No.: 12/192,743

(22) Filed: Aug. 15, 2008

Related U.S. Application Data
(60) Provisional application No. 60/955,916, filed on Aug. 15, 2007.

(51) Int. Cl. B01D 21/30

(52) U.S. Cl. 210/136

(57) ABSTRACT

A below-grade sewer reservoir provides a compartment for storing excess sewage in the event of excessive rainfall and sewage backup. An inlet pipe allows sewage to flow into the reservoir from a standard sanitary sewer pipe, and an outlet check valve on the output side of the reservoir permits normal flow to occur through the reservoir and prevents backflow of sewage when the mains are flooded

This application claims priority to U.S. Provisional Application Ser. No. 60/955,916, filed on Aug. 15, 2007.

### FIELD OF INVENTION

This invention relates to a plumbing device, and more specifically to a reservoir to accumulate raw sewage to permit outflow lines to clear thereby preventing backups during rainstorms and similar events.

### BACKGROUND OF INVENTION

Excessive rainfall causes a decline in the rate of sewer drainage. In low lying areas, especially in the Gulf Coast region of the United States, water levels can rise significantly from heavy rainfall or storm surges resulting from the approach of tropical storms or hurricanes. Therefore, there is a need for some place for sewage to accumulate while sewer levels lower thereby preventing raw sewage from backing up into homes, business and warehouses. This invention may also prevent flooding due to sewage backup by storing excess sewage until outflow returns to normal. This is especially helpful in older neighborhoods where sewer capacity is smaller than demand peaks.

### SUMMARY OF INVENTION

The present invention is a sewer reservoir, comprising a below-grade collector compartment. The collector compartment provides an opening on the inlet side for receiving sewage flow, an access hatch at the top of the compartment for periodic servicing, an opening on the outlet side for directing sewage flow to a main sewer, and a one-way check valve on the outlet side wherein sewage backflow into the reservoir is prevented in the case of excess flow or sewage backup.

### BRIEF DESCRIPTION OF DRAWINGS

FIG. 1 is an overall schematic drawing of the principal components of a below-grade sewer reservoir in accordance with the preferred embodiment of the present invention wherein the reservoir has a prismatic configuration.

FIG. 2 is a top view of the embodiment of the design as shown in FIG. 1.

FIG. 3 is an end-view of the embodiment of the design as shown in FIG. 1.

FIG. 4 is a side view of the top of the design as shown in FIG. 1.

FIG. 5 is an alternative embodiment of the design showing a tapered barrel-shaped collector compartment.

FIG. 6 is an alternative embodiment of the design showing a straight barrel-shaped collector compartment.

FIG. 7 is an alternative embodiment of the design showing the barrel collector with the inlet elevated above the outlet thereby providing a non-collinear input and output.

### DETAILED DESCRIPTION

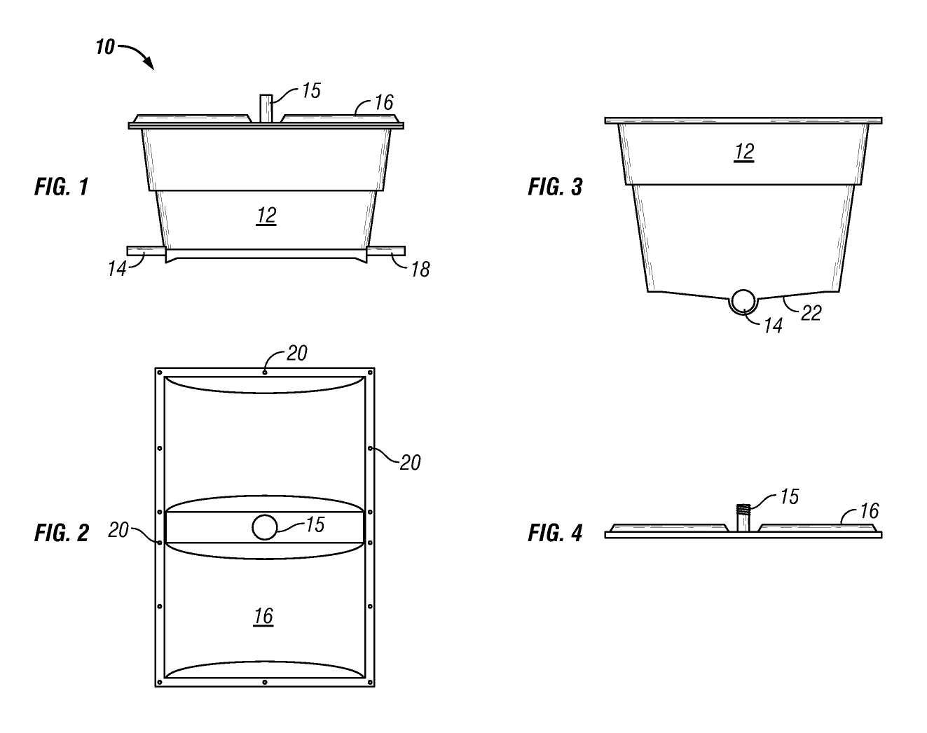

FIG. 1 illustrates the principal components of a design for a below-grade sewer reservoir 10. The collector compartment 12 stores excess sewage in the event of sewage backup. An inlet 14 provides a means for sewage flow into the compartment 12 from a standard sanitary sewer line from a house, business or the like. An access hatch or top 16 at the top of the compartment for visual inspection or periodic servicing, and an outlet 18 equipped with a check valve to allow sewage to flow into the main sewer lines while preventing backflow from said line.

The collector compartment 12 is buried in the ground to a depth so the bottom flow path is collinear with the existing sewer line. Sewage flows through the compartment as through the sewage line during normal conditions, but is stored in the compartment 12 in the event of excessive rainfall or sewage backup on the outlet side of the reservoir, which closes the backflow valve and prevents further reverse flow of the sewage into the inlet side of the reservoir. Flow from the sewage line passes into the collector compartment 12 and passes through a one-way outlet or check valve 18, thereby preventing backflow of sewage in the event of excess sewage or sewage blockage on the outflow side of the compartment. In the normal operation of this system, sewage is received from the inlet pipe 14 and flows immediately through the bottom of collector compartment 12 and out the outlet side past the backflow valve 18, which will be open.

The collector compartment 12 is preferably formed from fiberglass which is both lightweight and resistant to rot after placement in the ground. Alternatively, collector compartment 12 could be fabricated from concrete or metal without departing from the spirit or intent of this invention.

As more fully shown in FIG. 2, the top for the present collector compartment provides a reinforced, ridge cover 16 for the collector compartment 12 providing means for attachment such as screws or bolts 20 for affixing the top to the collector compartment 12. Tubing 15 can be inserted in the top 16 to extend to the finished grade to permit cleaning or servicing of the collector. A top can be placed over the opening and secured thereto such as by screw or threads (not shown), all in a manner well known in the industry.

FIG. 3 is an end view of the preferred embodiment showing the inlet 14 into which the sanitary drain line from the house or business is directed and attached in a manner well known to plumbers and the construction trades. The prismatic shape of the collector compartment 12 can be readily appreciated from this end view showing the sloping bottom 22 of the collector compartment 12, at the bottom of which is located the inlet 14 for the sewage. The prismatic shape of the collector compartment 12 facilitates the flow of sewage along the bottom of the collector to the outlet shown in FIG. 1 at 18. The outlet 18 is collinear with the inlet 14 as shown in FIG. 3. Alternative designs could provide an inlet elevated from the outlet side to further assist gravitational flow into the outlet. Additional alternative designs could provide sloping bottoms both along with longitudinal axis of the collector compartment and from the inlet to the outlet side of the collector. Each of these designs could be readily fashioned from the same materials used to form the preferred embodiment without departing from the spirit or intent of the present invention.

As shown in FIG. 4 the top 16 can be fitted with a tube 15 providing threads to affix a cap to the top of the tube which may be adjusted in length to reach the surface of the grade, thereby permitting pumping of the collector if needed or visual inspection of the integrity of the collector department without digging up the entire compartment.

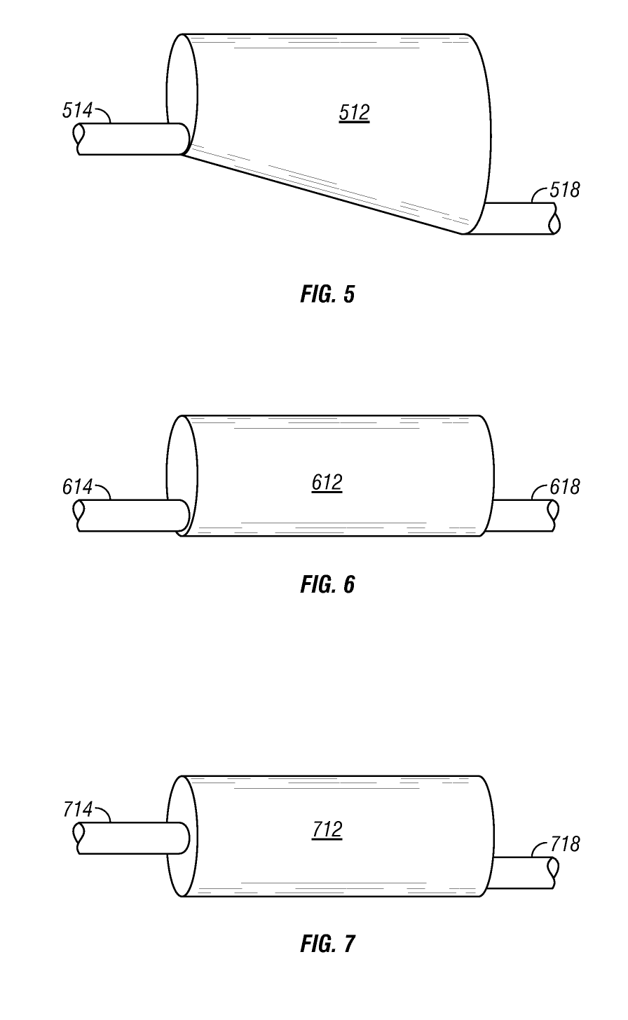

In another embodiment of the invention, the collector compartment 512 may have a barrel configuration as shown in FIG. 5, wherein the inlet opening 514 is located higher than the outlet opening 518 to assist flow via gravitation. Alternatively, the collector barrel 612 could provide a straight barrel shaped collector compartment and an inlet 614 and an outlet 618 collinear with each other. Moreover, as an additional alternative the barrel shaped configuration could provide an inlet 714 elevated from the longitudinal plane of the outlet 718.

Numerous embodiments and alternatives thereof have been disclosed. While the above disclosure includes the best mode belief in carrying out the invention as contemplated by the named inventors, not all possible alternatives have been disclosed. For that reason, the scope and limitation of the present invention is not to be restricted to the above disclosure, but is instead to be defined and construed by the appended claims.

What is claimed is:

1. A sewer reservoir comprising:
a below-grade collector compartment;
an opening on an inlet side pipe of said collector compartment for receiving sewage flow;
an access hatch on top of said collector compartment for periodic servicing;
an outlet side pipe directing sewage flow from said collector compartment to a main sewer; and
a one-way check valve on the outlet side pipe to prevent sewage backflow into the reservoir in the case of sewage backup from the main sewer.

2. The sewer reservoir of claim 1 wherein the below-grade collector compartment is prismatically shaped.

3. The sewer reservoir of claim 1 wherein the below-grade collector compartment is barrel shaped.

4. The sewer reservoir of claim 1 wherein the opening on an inlet side pipe is collinear with the outlet side pipe.

5. The sewer reservoir of claim 1 wherein the opening on an inlet side pipe is elevated above the longitudinal axis of the outlet side pipe.
